(19) United States
(12) Patent Application Publication
(10) Pub. No.: US 2024/0367336 A1
(43) Pub. Date: Nov. 7, 2024

(54) HANDHELD POWER TOOL

(71) Applicant: HUSQVARNA AB, Huskvarna (SE)

(72) Inventors: Per-Arne Jarnland, Huskvarna (SE); Joel Ahlander, Jonkoping (SE); Martin Lindekull, Norrahammar (SE); Jacob Krantz, Lekeryd (SE); Andreas Jonsson, Huskvarna (SE)

(21) Appl. No.: 18/557,692

(22) PCT Filed: Mar. 29, 2022
(86) PCT No.: PCT/SE2022/050311

§ 371 Date: Oct. 27, 2023

(30) Foreign Application Priority Data
Apr. 28, 2021 (SE) 2150541-7

(51) Int. Cl. B27B 17/00; F02B 75/02

(52) U.S. Cl. CPC B27B 17/0008; B27B 17/0033; F02B 2075/025

(57) ABSTRACT

A handheld power tool (1) is disclosed comprising a tool (30) and an engine (10) configured to power the tool (30). The power tool (1) comprises a handle portion (4) and an engine portion (6) resiliently suspended to the handle portion (4). The power tool (1) has a void space (12, 12′) between the handle portion (4) and the engine portion (6) extending along a separation plane (Sp). The separation plane (Sp) is transversal to a horizontal centre plane (Hcp) and to a vertical centre plane (Vcp) of the power tool (1). The power tool (1) comprises a control device (28) mounted to the handheld power tool (1) such that the angle (a1) between the separation plane (Sp) and one of two larger sides (s1, s1′) of the control device (28) is less than 35 degrees or is less than 25 degrees.

### TECHNICAL FIELD

The present disclosure relates to a handheld power tool comprising a tool and an engine configured to power the tool. The handheld power tool further comprises a control device accommodating an electronic control unit configured to control operation of at least one electronic component of the power tool.

### BACKGROUND

A handheld power tool is a tool intended to be supported by one or two hands of a user during operation. Moreover, a handheld power tool comprises a tool which can be driven by a power source other than solely manual labour. The power source may for example comprise a combustion engine, an electric motor, a pneumatic motor, or the like. Today, there are many kinds of power tools available on the market. Examples are chain saws, circular saws, trimmers, hedge trimmers, multi-tools, and the like. Power tools are for example used in industry, in construction, in gardens, for housework tasks, and around houses for purposes of cutting, shaping, sanding, grinding, routing, polishing, and the like.

Power tools of various kind are associated with some mutual problems. One problem is compactness and weight. That is, it is an advantage if a power tool can be designed to be compact and have a low weight. One reason for this is that the power tool becomes simpler and less burdensome to use. Moreover, a lighter power tool puts less strain on hands, arms, and back of a user. However, modern power tools can require several additional features, functions, and arrangements as compared to older types of power tools. Another problem is that a power tool usually generates a lot of vibration during use. In more detail, the operation of the tool may generate vibration as well as the operation of the power source powering the tool. Vibrations are especially problematic in handheld power tools because these types of power tools are supported by one or two hands of a user during use.

Some handheld power tools comprise a so called vibration split. These power tools comprise a handle portion comprising one or more handles and a tool portion comprising the tool and usually also the power source powering the tool, wherein the tool portion is resiliently suspended to the handle portion. In this manner, significantly less vibration is transferred from the tool and the power source of the power tool to the handle portion of the power tool. However, the use of a vibration split puts demands on the design of the power tool and it may cause difficulties in obtaining a compact and lightweight power tool. Moreover, the use of a vibration split may cause difficulties in arranging additional arrangements and systems in the power tool without redesigning the power tool.

As indicated above, some handheld power tools comprise a combustion engine configured to power the tool. In most cases, two-stroke petrol engines are used because of the mechanical simplicity, light weight, and high power-to-weight ratio as compared to other types of combustion engines. A two-stroke engine is a type of internal combustion engine which completes a power cycle with two strokes of the piston during only one crankshaft revolution. The uppermost position of a piston in a cylinder is usually referred to as the top dead centre and the lowermost position of the piston in the cylinder is usually referred to as the bottom dead centre. Compared to four-stroke engines, two-stroke engines have a greatly reduced number of moving parts, and consequently can be made more compact and significantly lighter.

Most small sized two-stroke engines are crankcase-scavenged engines meaning that these engines use the area below the piston as a charging pump to build up pressure in the crankcase during the power stroke of the piston. Traditionally, two-stroke engines have usually been provided with a carburetor arranged to supply an air/fuel mixture to the crankcase. In the power stroke of a two-stroke engine, the increased pressure and temperature in the cylinder obtained by the combustion of fuel is partially converted into mechanical work supplied to a crankshaft of the engine. At the same time, the pressure in the crankcase increases as a result of the movement of the piston towards the bottom dead centre. An exhaust port arranged in the cylinder wall is opened to allow exhaust gases to flow out from the cylinder when the piston reaches a first position relative the cylinder in its movement towards the bottom dead centre. The piston continues the movement towards the bottom dead centre and when it reaches a second position, below the first position, an inlet port arranged in the cylinder wall is opened. The inlet port is fluidly connected to the crankcase via a scavenging channel. The air/fuel mixture in the crankcase is forced to flow into the cylinder via the inlet port by the overpressure in the crankcase.

Accordingly, as understood from the above, in this type of engine, the exhaust port, and the inlet port in the cylinder are open simultaneously in the scavenging phase of the engine, i.e. when the piston is in the region of a bottom dead centre. As a result thereof, some air/fuel mixture may flow through the cylinder from the inlet port to the exhaust port in the scavenging phase. Therefore, a problem associated with small sized two-stroke engines is emission of unburned hydrocarbon, i.e. unburned fuel. A way to counter this problem is to provide the engine with a stratified scavenging arrangement.

In such engines, the piston can be provided with an aperture arranged to superimpose the scavenging channel and a stratified scavenging intake in the cylinder wall when the piston is in a region of the top dead centre. When the piston is in this position, clean air, i.e. air without added fuel, can flow from the stratified scavenging intake into the scavenging channel. As a result thereof, when the piston reaches the second position, referred to above, in which the inlet port is opened, clean air will first enter the cylinder before the air/fuel mixture further down in the scavenging channel reaches the cylinder. In this manner, less fuel will flow out through the exhaust port in the scavenging phase and the emission of unburned hydrocarbon can thereby be significantly reduced.

Drawbacks with stratified scavenging arrangements are that they occupy space and add complexity to two-stroke engines. That is, the components and structures needed, such as channels, inlet ducts, throttling devices, and the like, occupy space, add weight and complexity to a power tool. Accordingly, a stratified scavenging arrangement adds to the above mentioned problems of making a power tool compact, and thereby also lightweight, especially if the power tool comprises a so called vibration split mentioned above. Moreover, in general, on today's consumer market, it is an advantage if products, such as handheld power tools and associated components, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a handheld power tool comprising a tool and an engine configured to power the tool. The power tool comprises a handle portion comprising a handle and an engine portion comprising the engine. The engine portion is resiliently suspended to the handle portion via a number of resilient members. The power tool has a horizontal centre plane being parallel to a flat horizontal support surface when the power tool is positioned in a usual upright parking position thereon. The power tool further has a vertical centre plane being perpendicular to the horizontal centre plane and a void space between the handle portion and the engine portion extending along a separation plane. The separation plane is transversal to the horizontal centre plane and is transversal to the vertical centre plane. The power tool comprises a control device accommodating an electronic control unit configured to control operation of at least one electronic component of the power tool. The control device comprises two larger sides having larger dimensions than other sides of the control device. The control device is mounted to the handheld power tool such that the angle between the separation plane and one of the two larger sides is less than 35 degrees or is less than 25 degrees.

Thereby, a handheld power tool is provided having conditions for being compact and having a low vertical height while providing conditions for arranging the handheld power tool with one or more further systems and arrangements, such as for example a stratified scavenging intake channel. This is because the void space between the handle portion and the engine portion extends along a separation plane being transversal to the horizontal centre plane and to the vertical centre plane of the handheld power tool.

That is, some other types of handheld power tools may comprise a so called vertical vibration split in which a void space extends in a separation plane which is parallel to a vertical centre plane of the handheld power tool. In such power tools, it is not possible, or is at least difficult, to provide the handheld power tool with one or more further systems and arrangements, such as for example a stratified scavenging intake channel, without significantly increasing the size of handheld power tool and/or redesigning the handheld power tool. In addition, the use of a vertical vibration split normally leads to a handheld power tool having a relatively large vertical height.

Moreover, since the control device is mounted to the handheld power tool such that the angle between the separation plane and one of the two larger sides is less than 35 degrees or is less than 25 degrees, the control device can be mounted to the handheld power tool in a space efficient manner. This is because the control device can be substantially aligned with the direction of the separation plane of the vibration split, while the direction of the separation plane of the vibration split allows the use of one or more further systems and arrangements, such as for example a stratified scavenging intake channel.

Accordingly, a handheld power tool is provided overcoming, or at least alleviating, at least some of the above-mentioned problems and drawbacks. As a result, the above-mentioned object is achieved.

Optionally, the control device is mounted adjacent to the void space. Thereby, the control device is mounted to the handheld power tool in a space efficient manner which can provide space for one or more further systems and arrangements in the handheld power tool without significantly increasing the size of the handheld power tool.

Optionally, the control device is mounted in the engine portion. Thereby, a handheld power tool is provided having conditions for mounting the control device is a space efficient manner to the engine portion while providing conditions for arranging the engine portion of the handheld power tool with one or more further systems and arrangements, such as for example a stratified scavenging intake channel, while ensuring a compact handheld power tool having a low vertical height. Moreover, the routing of one or more wires between the control device and the least one electronic component of the power tool may be facilitated.

Optionally, the control device is mounted in the handle portion. Thereby, a handheld power tool is provided having conditions for mounting the control device is a space efficient manner to the handheld power tool while providing more space for arranging one or more further systems and arrangements in the engine portion of the handheld power tool, such as for example a stratified scavenging intake channel. Moreover, because the control device is mounted in the handle portion of the handheld power tool, the control device may be subjected to less vibration during operation of the handheld power tool.

Optionally, the power tool comprises a fuel tank arranged in the handle portion. Thereby, conditions are provided for a handheld power tool being compact and having a low vertical height while providing space for arranging one or more further systems and arrangements in the engine portion of the handheld power tool. In addition, a more advantageous weight distribution of the power tool can be obtained.

Optionally, an outer surface of the fuel tank faces the void space. Thereby, conditions are provided for a handheld power tool being compact and having a low vertical height while providing space for arranging one or more further systems and arrangements in the engine portion of the handheld power tool.

Optionally, the angle between the separation plane and the horizontal centre plane of the power tool is within the range of 10-70 degrees or is within the range of 18-45 degrees. Thereby, a handheld power tool is provided having conditions for being compact and having a low vertical height while providing conditions for arranging the handheld power tool with one or more further systems and arrangements, such as for example a stratified scavenging intake channel, without impairing compactness and the vertical height of the handheld power tool.

Optionally, the engine is a two stroke engine comprising a cylinder, a piston arranged to reciprocate in the cylinder between a bottom dead centre and a top dead centre, a crankcase, an air inlet connected to the crankcase, and a stratified scavenging intake channel configured to conduct air along a first direction to the cylinder, wherein the angle between the separation plane and the first direction is less than 35 degrees or is less than 25 degrees. Thereby, since the engine of the handheld power tool comprises a stratified scavenging intake channel, the engine has conditions for a significant reduction of emission of unburned hydrocarbon during operation. Accordingly, a handheld power tool is provided having conditions for a powerful and low weight engine capable of operating in a more environmentally friendly manner. Moreover, since the angle between the separation plane and the first direction, i.e. the direction of the stratified scavenging intake channel, is less than 35 degrees or is less than 25 degrees, conditions are provided for a compact handheld power tool having a low vertical height despite the fact that the handheld power tool comprises the stratified scavenging intake channel and the control device each occupying space.

Optionally, the control device is mounted to the handheld power tool such that the angle between the first direction and one of the two larger sides is less than 25 degrees or is less than 15 degrees. Thereby, conditions are provided for a compact handheld power tool having a low vertical height despite the fact that the handheld power tool comprises the stratified scavenging intake channel, the vibration split, and the control device which each occupies space.

Optionally, the control device is arranged adjacent to the stratified scavenging intake channel. Thereby, the control device is arranged on the handheld power tool in a space efficient manner which provides conditions for a more compact handheld power tool having a low vertical height despite the fact that the handheld power tool comprises the stratified scavenging intake channel, the vibration split, and the control device.

Optionally, the engine comprises a scavenging channel configured to conduct an air fuel mixture from the crankcase to the cylinder when the piston is in a region of the bottom dead centre, and wherein the piston comprises a mantle surface provided with an aperture arranged to superimpose the stratified scavenging intake channel and the scavenging channel when the piston is in a region of the top dead centre. Thereby, an engine is provided having conditions for generating low amounts of unburned hydrocarbon during operation while the engine has conditions and characteristics suitable for being manufactured and assembled in a cost-efficient manner.

Optionally, the power tool comprises a fuel injector configured to inject fuel into the crankcase or into the air inlet. Thereby, a handheld power tool is provided comprising an engine having conditions for operating in a more fuel efficient and environmentally friendly manner, while having conditions for being compact and having a low vertical height.

Optionally, the electronic control unit of the control device is configured to control operation of the fuel injector. Thereby, a handheld power tool is provided comprising an engine having conditions for operating in a more fuel efficient and environmentally friendly manner, while having conditions for being compact and having a low vertical height.

Optionally, the power tool is a chainsaw. Thereby, a chainsaw is provided having conditions for being compact and having a low vertical height while providing conditions for arranging the chainsaw with one or more further systems and arrangements, such as for example a stratified scavenging intake channel. This is because the void space between the handle portion and the engine portion extends along a separation plane being transversal to the horizontal centre plane and to the vertical centre plane of the chainsaw.

That is, some other types of chainsaws may comprise a so called vertical vibration split in which a void space extends in a separation plane which is parallel to a vertical centre plane of the chainsaw. In such chainsaws, it is not possible, or is at least difficult, to provide the chainsaw with one or more further systems and arrangements, such as for example a stratified scavenging intake channel, without significantly increasing the size of chainsaw and/or redesigning the chainsaw. In addition, the use of a vertical vibration split normally leads to a chainsaw having a relatively large vertical height.

Since the control device is mounted to the chainsaw such that the angle between the separation plane and one of the two larger sides is less than 35 degrees or is less than 25 degrees, the control device can be mounted to the chainsaw in a space efficient manner. This is because the control device can be substantially aligned with the direction of the separation plane of the vibration split, while the direction of the separation plane of the vibration split allows the use of one or more further systems and arrangements, such as for example a stratified scavenging intake channel.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a first side view of a handheld power tool according to some embodiments of the present disclosure,

FIG. 2 illustrates a front view of the handheld power tool illustrated in FIG. 1,

FIG. 3 illustrates a second side view of the handheld power tool illustrated in FIG. 1 and FIG. 2, wherein a handle portion is separated from an engine portion of the power tool,

FIG. 4 schematically illustrates a control device of the handheld power tool illustrated in FIG. 1

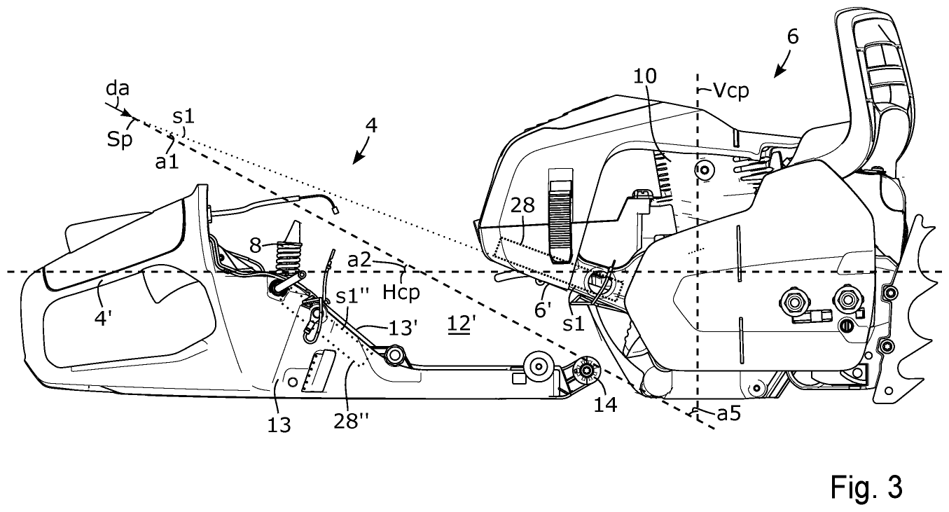

FIG. 3,

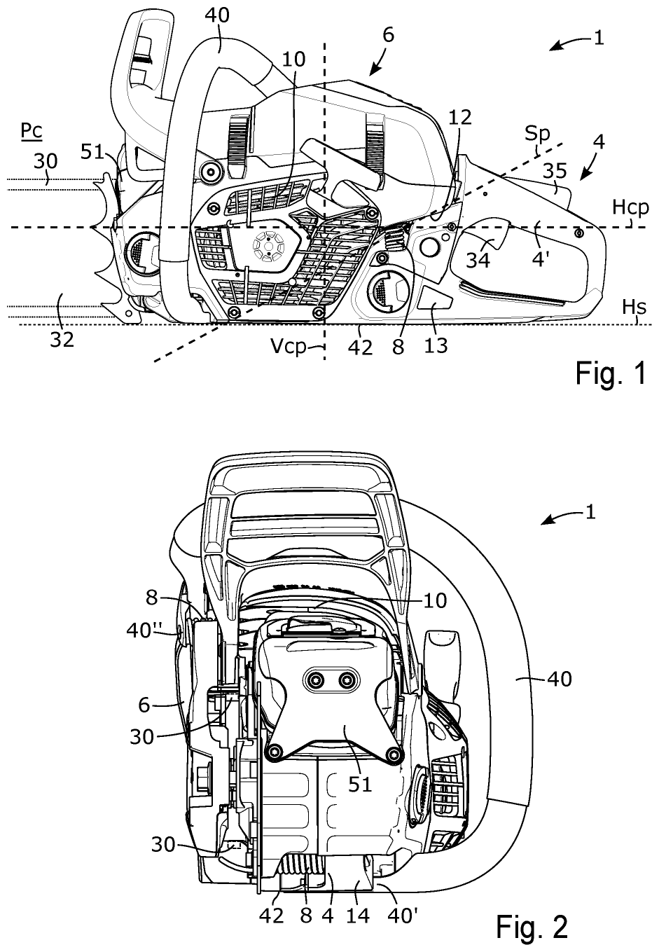

FIG. 5 illustrates a perspective view of a piston of an engine of the handheld power tool illustrated in FIG. 1-FIG. 3,

FIG. 6 illustrates a cross section of the handheld power tool illustrated in FIG. 1-FIG. 3, and

FIG. 7 illustrates the cross section of the handheld power tool illustrated FIG. 6 in which a piston of the engine is illustrated in a bottom dead centre.

### DETAILED DESCRIPTION

Aspects of the present invention will now be described more fully. Like numbers refer to like elements throughout. Well-known functions or constructions will not necessarily be described in detail for brevity and/or clarity.

FIG. 1 illustrates a first side view of a handheld power tool 1 according to some embodiments of the present disclosure. The handheld power tool 1 comprises a tool 30 and an engine 10 configured to power the tool 30. According to the illustrated embodiments, the handheld power tool 1 is a chainsaw comprising a tool 30 in the form of a cutting chain movably arranged around a guide bar 32. In FIG. 1, the cutting chain and the guide bar 32 are schematically illustrated. During operation of the handheld power tool 1, the engine 10 is rotating the cutting chain around the guide bar 32. According to further embodiments, the handheld power tool 1, as referred to herein, may be another type of handheld power tool 1 than a chainsaw, such as for example a circular saw, a trimmer, a hedge trimmer, a multi-tool, or the like.

The handheld power tool 1 comprises a handle portion 4 comprising a handle 4′ and an engine portion 6 comprising the engine 10. Moreover, according to the illustrated embodiments, the handheld power tool 1 comprises a second handle 40 attached to the handle portion 4 of the handheld power tool 1. The handle 4′ may also be referred to as a first handle or a rear handle. The second handle 40 may also be referred to as a front handle. According to the illustrated embodiments, the handheld power tool 1 is configured to be supported by two hands of a user during operation of the handheld power tool 1, i.e. is configured to be supported by one hand grabbing the handle 4′ and the other hand grabbing the second handle 40. According to the illustrated embodiments, the handheld power tool 1 comprises a throttle actuator 34 and a safety button 35 arranged on the handle 4′. The feature that the handheld power tool 1 is “handheld” means that the handheld power tool 1 is configured to be supported by one or two hands during operation of the handheld power tool 1. However, for reasons of brevity and clarity, the handheld power tool 1 is in some places herein simply referred to as “the power tool 1”.

The engine portion 6 of the power tool 1 is resiliently suspended to the handle portion 4 via a number of resilient members 8. In FIG. 1, one resilient member 8 can be seen. However, as is explained below, the power tool 1 according to the illustrated embodiments comprises more than one resilient member 8 resiliently suspending the engine portion 6 to the handle portion 4. In FIG. 1, the power tool 1 is illustrated straight towards a first side of the power tool 1. Moreover, in FIG. 1, the power tool 1 is illustrated as positioned in a usual upright parking position on a flat horizontal support surface Hs. When the power tool 1 is positioned in the usual upright parking position on a flat horizontal support surface Hs, a bottom side 42 of the handheld power tool 1 is resting, i.e. abutting, against the flat horizontal support surface Hs. Moreover, according to the illustrated embodiments, an intended cutting direction of the tool 30 of the handheld power tool 1 is substantially perpendicular to the flat horizontal support surface Hs when the power tool 1 is positioned in the usual upright parking position on the flat horizontal support surface Hs. The intended cutting direction of the tool 30 coincides with a cutting plane Pc of the tool 30. In FIG. 1, the power tool 1 is illustrated such that the cutting plane Pc of the tool 30 is perpendicular to the viewing direction.

Furthermore, the handles 4′, 40 of the handheld power tool 1 can be accessed in an easy manner when the power tool 1 is positioned in the usual upright parking position on the flat horizontal support surface Hs because the intended grabbing directions of the handles 4′, 40 are substantially perpendicular to the flat horizontal support surface Hs when the power tool 1 is positioned in the usual upright parking position on the flat horizontal support surface Hs. The reason for the use of the word “usual” herein in the expression “usual upright parking position” is that the handheld power tool 1 could possibly be positioned on a flat horizontal support surface Hs in another orientation relative to the flat horizontal support surface Hs, such as for example laid on the side on the flat horizontal support surface Hs. However, if so, the intended cutting direction of the tool 30 and the intended grabbing direction of the handle 4′, will not be substantially perpendicular to the flat horizontal support surface Hs. Moreover, if so, the bottom side 42 of the handheld power tool 1 will apparently not rest against the flat horizontal support surface Hs.

As is indicated in FIG. 1, the power tool 1 has a horizontal centre plane Hcp being parallel to the flat horizontal support surface Hs when the power tool 1 is positioned in a usual upright parking position on the flat horizontal support surface Hs. The horizontal centre plane Hcp thus extends in a direction parallel to the flat horizontal support surface Hs, and thus also parallel to the bottom side 42 of the handheld power tool 1, through a centre of the power tool 1. According to the illustrated embodiments, the horizontal centre plane Hcp is substantially perpendicular to the cutting plane Pc of the tool 30. Moreover, as is indicated in FIG. 1, the power tool 1 further has a vertical centre plane Vcp being perpendicular to the horizontal centre plane Hcp. The vertical centre plane Vcp thus extends in a direction perpendicular to the flat horizontal support surface Hs, and thus also perpendicular to the bottom side 42 of the handheld power tool 1, through a centre of the power tool 1. In FIG. 1, the handheld power tool 1 is illustrated in a viewing direction parallel to the vertical centre plane Vcp and parallel to the horizontal centre plane Hcp. According to the illustrated embodiments, the vertical centre plane Vcp is substantially perpendicular to the cutting plane Pc of the tool 30.

FIG. 2 illustrates a front view of the handheld power tool 1 illustrated in FIG. 1. In FIG. 2, the handheld power tool 1 is illustrated in a viewing direction perpendicular to the vertical centre plane Vcp indicated in FIG. 1. As is further explained herein, the handheld power tool 1 according to the illustrated embodiments comprises an engine 10 in the form on an internal combustion engine. In FIG. 1 and FIG. 2, a muffler 51 of the engine 10 is indicated. Thus, in FIG. 2, the handheld power tool 1 is illustrated such that a front side of the handheld power tool 1 can be seen, which front side comprises the muffler 51 and the tool 30 of the power tool 1. Also in FIG. 2, the tool 30 is schematically indicated.

Moreover, in FIG. 2, two other resilient members 8 of the power tool 1 can be seen. Below, simultaneous reference is made to FIG. 1 and FIG. 2, if not indicated otherwise. As seen in FIG. 1 and FIG. 2, according to the illustrated embodiments, the resilient members 8 are coil springs. According to further embodiments, the resilient members 8 may be another type of resilient element or member, such as for example a bushing made of an elastic material.

Furthermore, as seen in FIG. 2, according to the illustrated embodiments, a first end 40′ of the second handle 40 is rigidly attached to a portion 14 of the handle portion 4 whereas a second end 40″ of the second handle 40 is supported relative to the engine portion 6 via one of the resilient members 8.

FIG. 3 illustrates a second side view of the handheld power tool 1 illustrated in FIG. 1 and FIG. 2, wherein the handle portion 4 is separated from the engine portion 6. In FIG. 3, the handheld power tool 1 is illustrated in a viewing direction parallel to the vertical centre plane Vcp and parallel to the horizontal centre plane Hcp. Moreover, in FIG. 3 some components of the handheld power tool 1 have been omitted for reasons of brevity and clarity, such as the tool 30 and the second handle 40 indicated in FIG. 1 and FIG. 2. However, the portion 14 of the handle portion 4, to which the second handle 40 is attached, can be seen and is indicated in FIG. 3.

As is indicated in FIG. 1, the handheld power tool 1 has a void space 12 between the handle portion 4 and the engine portion 6. The void space 12 is indicated with the reference sign 12′ in FIG. 3. Below, simultaneous reference is made to FIG. 1-FIG. 3, if not indicated otherwise. The void space 12, 12′ between the handle portion 4 and the engine portion 6 extends along a separation plane Sp. As can be seen in FIG. 1 and FIG. 3, the separation plane Sp is transversal to the horizontal centre plane Hcp and is transversal to the vertical centre plane Vcp. In more detail, according to the illustrated embodiments, the angle a2 between the separation plane Sp and the horizontal centre plane Hcp of the power tool 1 is approximately 28 degrees. According to further embodiments, the angle a2 between the separation plane Sp and the horizontal centre plane Hcp of the power tool 1 may be within the range of 10-70 degrees or may be within the range of 18-45 degrees.

According to the illustrated embodiments, the angle a2 between the separation plane Sp and the horizontal centre plane Hcp of the power tool 1 is smaller than the angle a5 between the separation plane Sp and the vertical centre plane Vcp of the power tool 1. Such a separation plane Sp can also be referred to as a horizontal split between the handle portion 4 and the engine portion 6. The horizontal split allows a compact design and a low vertical height of the power tool 1, as is further explained herein. The vertical height of the power tool 1 may be measured in a vertical direction of the power tool 1, i.e. in a direction parallel to the vertical centre plane Vcp of the power tool 1.

As understood from the herein described, the void space 12, 12′ is formed in an interface between the handle portion 4 and the engine portion 6. Each of the handle portion 4 and the engine portion 6 comprises a respective outer surface 13′, 6′ facing the void space 12, 12′. In other words, an outer surface 13′ of the handle portion 4 and an outer surface 6′ of the engine portion 6 forms delimiting surfaces of the void space 12, 12′ between the handle portion 4 and the engine portion 6. As seen in FIG. 3, these outer surface 13′, 6′ may not extend in the same direction relative to the horizontal centre plane Hcp along the full length of the outer surfaces 13′, 6′. In other words, the void space 12, 12′ between the handle portion 4 and the engine portion 6 may necessarily not extend along a flat separation plane Sp. Instead, the separation plane Sp, as referred to herein, may comprise a number of sections being curved/undulated.

According to such embodiments, the feature that the separation plane Sp is transversal to the horizontal centre plane Hcp and is transversal to the vertical centre plane Vcp means that an average direction da of the separation plane Sp, located in an interface between the handle portion 4 and the engine portion 6, is transversal to the horizontal centre plane Hcp and is transversal to the vertical centre plane Vcp. Likewise, in such embodiments, the feature that the angle a2 between the separation plane Sp and the horizontal centre plane Hcp of the power tool 1 is within the range of 10-70 degrees or is within the range of 18-45 degrees means that the angle a2 between the horizontal centre plane Hcp of the power tool 1 and the average direction da of the separation plane Sp, located in an interface between the handle portion 4 and the engine portion 6, is within the range of 10-70 degrees or is within the range of 18-45 degrees.

However, according to some embodiments of the herein described, the separation plane Sp between the handle portion 4 and the engine portion 6 may be at least substantially planar. As understood from the above described, the separation plane Sp, the void space 12, 12′, and/or the interface between the handle portion 4 and the engine portion 6 may also be referred to as a vibration split.

As is indicated in FIG. 3, the handheld power tool 1 comprises a control device 28. The control device 28 accommodates an electronic control unit configured to control operation of at least one electronic component of the power tool 1, as is further explained herein.

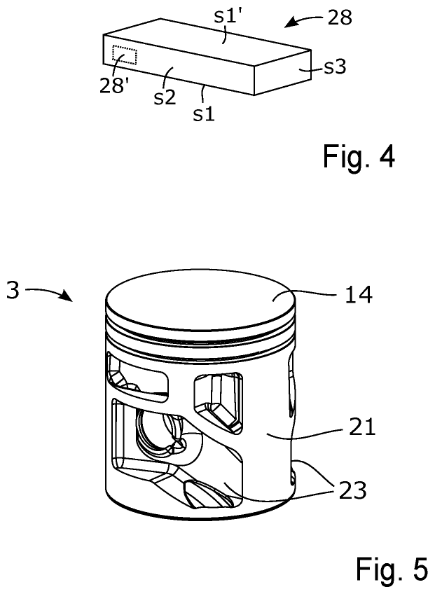

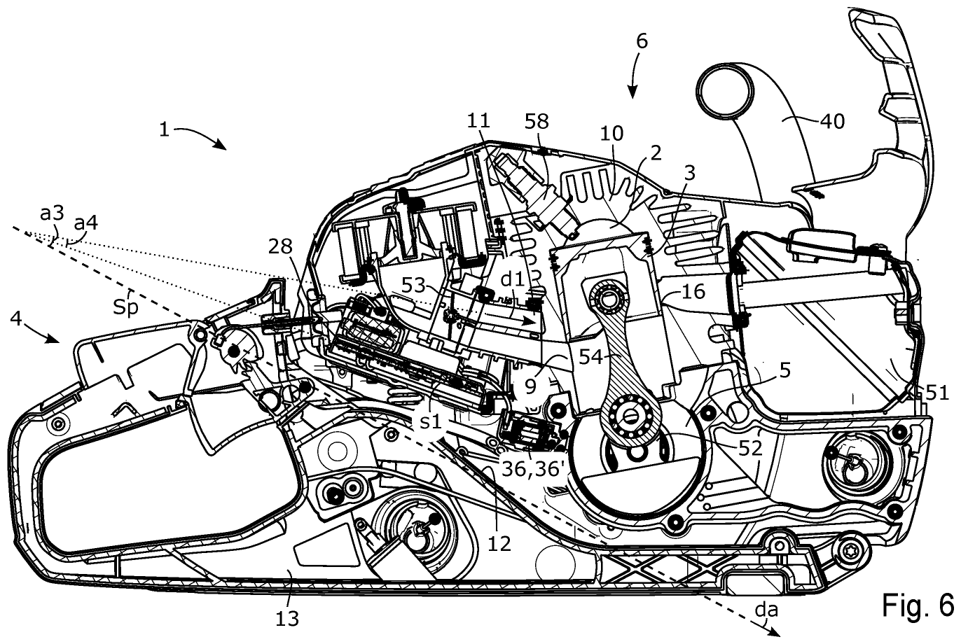

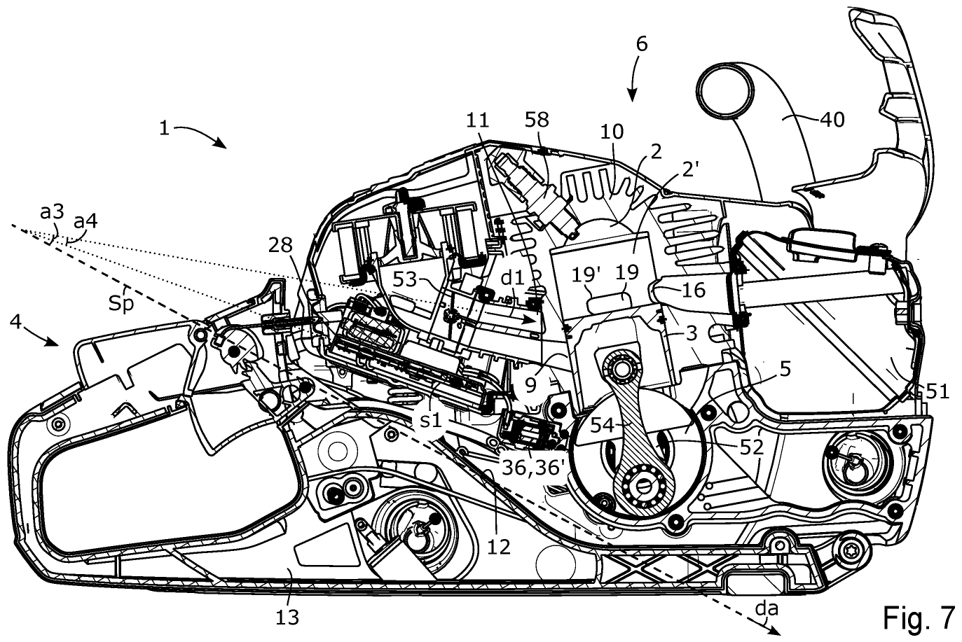

FIG. 4 schematically illustrates the control device 28 of the handheld power tool 1 illustrated in FIG. 1-FIG. 3. In FIG. 4, the electronic control unit 28′ of the control device 28 is schematically indicated. As indicated in FIG. 4, the control device 28 comprises two larger sides s1, s1′ each having larger dimensions than other sides s2, s3 of the control device 28. That is, in more detail, according to the illustrated embodiments, the control device 28 is formed as a rectangular cuboid having the form of a flat box comprising six sides s1, s1′, s2, s3, wherein four of the sides s1, s1′, s2, s3 are indicated in FIG. 4. As clearly seen, two of the sides s1, s1′ each has a larger size, i.e. a larger area, than other sides s2, s3 of the control device 28. The size/area of a side s1, s1′, s2, s3 of the control device 28 may be obtained by multiplying the length of two sides of the control device 28, wherein the two sides are perpendicular to each other and each forms a delimiting surface of the side s1, s1′, s2, s3 being measured.

The control device 28 may have another form than the form of a rectangular cuboid. According to such embodiments, the two larger sides s1, s1′, as referred to herein, may be two sides/faces of the control device 28 having larger dimensions than other sides/faces of the control device 28. That is, the two larger sides s1, s1′ of the control device 28 having larger dimensions than other sides s2, s3 of the control device 28 can be determined by viewing the control device 28 while rotating the control device 28 in different directions around the point of centre of gravity of the control device 28 until the area of the control device 28, as seen from a viewing point/viewer, is maximized. When the area of the control device 28 is maximized, as seen from a viewing point/viewer, one of the two larger sides s1, s1′ will face the viewing point/viewer and the other of the two larger sides s1, s1′ will face away from the viewing point/viewer.

In FIG. 3, one of the two larger sides s1 is indicated. According to the illustrated embodiments, the control device 28 is mounted to the handheld power tool 1 such that the angle a1 between the separation plane Sp and one of the two larger sides s1, s1′ is approximately 7 degrees. According to further embodiments, the control device 28 may be mounted to the handheld power tool 1 such that the angle a1 between the separation plane Sp and one of the two larger sides s1, s1′ is less than 35 degrees, or is less than 25 degrees. In this manner, the control device 28 can be mounted to the handheld power tool 1 in a space efficient manner. This is because the control device 28 can be substantially aligned with the direction da of the separation plane Sp of the vibration split, while the direction da of the separation plane Sp of the vibration split allows the use of one or more further systems and arrangements, such as for example a stratified scavenging intake channel and the control device 28.

That is, some other types of handheld power tools may comprise a so called vertical vibration split in which a void space extends in a separation plane which is at least substantially parallel to a vertical centre plane of the handheld power tool. In such power tools, it is not possible, or is at least difficult, to provide the handheld power tool with one or more further systems and arrangements, such as for example a stratified scavenging intake channel, without significantly increasing the size of handheld power tool. In addition, the use of a vertical vibration split normally leads to a handheld power tool having a relatively large vertical height.

Moreover, as can be seen in FIG. 3, according to the illustrated embodiments, the control device 28 is mounted adjacent to the void space 12′. Since the void space 12′ extends along the separation plane Sp, the control device 28 is also mounted adjacent to the separation plane Sp according to the illustrated embodiments. Moreover, the control device 28 is mounted in the engine portion 6 adjacent to an outer wall 6′ of the engine portion 6 which faces the void space 12′. Furthermore, according to the illustrated embodiments, the control device 28 is mounted to the handheld power tool 1 such that at least one of the two larger sides s1 is substantially parallel to the outer wall 6′ of the engine portion 6 which outer wall 6′ faces the void space 12′. In this manner, a compact handheld power tool 1 can be provided having a low vertical height.

According to further embodiments of the herein described, the control device 28 may be mounted in the handle portion 4 of the power tool 1. Such an embodiment is schematically indicated in FIG. 3 where an alternative control device 28″ is schematically indicated in dotted lines. The power tool 1, as referred to herein may thus comprise the control device 28″ mounted in the handle portion 4 instead on the control device 28 mounted in the engine portion 6. As indicated in FIG. 1, the control device 28″ may be mounted in the handle portion 4 adjacent to an outer wall 13′ of the handle portion 4 which faces the void space 12′.

As indicated in FIG. 1 and FIG. 3, the power tool 1 comprises a fuel tank 13 arranged in the handle portion 4. According to the illustrated embodiments, the control device 28″ is arranged adjacent to an outer surface 13′ of the fuel tank 13. Also in these embodiments, the control device 28″ may be mounted to the handheld power tool 1 such that the a1 between the separation plane Sp and one of the two larger sides s1″ of the control device 28″ is less than 35 degrees or is less than 25 degrees. Moreover, also in these embodiments, the control device 28″ may be mounted to the handheld power tool 1 such that at least one of the two larger sides s1″ is substantially parallel to the outer wall 13′ of the handle portion 4 which faces the void space 12′.

Also in embodiments in which the control device 28 is mounted in the engine portion 6, the outer wall 13′ of the handle portion 4 which faces the void space 12′ may be an outer surface 13′ of the fuel tank 13. In embodiments in which the separation plane Sp comprises a number of sections being curved/undulated, the feature that the angle a1 between the separation plane Sp and one of the two larger sides s1, s1′, s1″ is less than 35 degrees, or is less than 25 degrees means that the angle a1 between one of the two larger sides s1, s1′, s1″ and the average direction da of the separation plane Sp, located in an interface between the handle portion 4 and the engine portion 6, is less than 35 degrees, or is less than 25 degrees.

FIG. 5 illustrates a perspective view of a piston 3 of the engine 10 of the handheld power tool 1 illustrated in FIG. 1-FIG. 3. The piston 3 comprises a mantle surface 21 provided with two apertures 23. As is further explained herein, the apertures 23 are arranged to superimpose a stratified scavenging intake channel and a scavenging channel of the engine of the handheld power tool when the piston 3 is in a region of a top dead centre. The features and functions of the piston 3 are further explained below.

FIG. 6 illustrates a cross section of the handheld power tool 1 illustrated in FIG. 1-FIG. 3. In FIG. 6, the cross section is made in a plane perpendicular to the horizontal centre plane Hcp and perpendicular to the vertical centre plane Vcp indicated in FIG. 1. However, in FIG. 6, the horizontal centre plane Hcp and the vertical centre plane Vcp have been omitted for reasons of brevity and clarity. In FIG. 6, different components and subsystems of the engine 10 of the power tool 1 can be more clearly seen.

According to the illustrated embodiments, the engine 10 is a two stroke engine comprising a cylinder 2 a piston 3 arranged to reciprocate in the cylinder 2 between a bottom dead centre and a top dead centre. In FIG. 6, the piston is illustrated as positioned in the top dead centre. The engine 10 further comprises a crankcase 5 and a crankshaft 52 arranged to rotate in the crankcase 5. Moreover, the engine 10 comprises a connecting rod 54 connecting the piston 3 to the crankshaft 52 such that the piston 3 reciprocates in the cylinder 2 between the bottom dead centre and the top dead centre upon rotation of the crankshaft 52.

The engine 10 further comprises a fuel injector 36. According to the illustrated embodiments, the fuel injector 36 is configured to inject fuel directly into the crankcase 5. The fuel injector 36 may be of a low-pressure type. Moreover, the engine 10 comprises an air inlet 9 connected to the crankcase 5, and a stratified scavenging intake channel 11 connected to the cylinder 2. Furthermore, the engine 10 comprises a throttle 53 configured to control the amount of air supplied to the air inlet 9 and to the stratified scavenging intake channel 11.

According to the illustrated embodiments, the engine 10 comprises a manifold arranged between the throttle 53 and the air inlet 9 and the stratified scavenging intake channel 11. According to further embodiments, the engine 10 may comprise two throttles, wherein one of the two throttles is configured to control the amount of air supplied to the air inlet 9 and the other of the two throttles is configured to control the amount of air supplied to the stratified scavenging intake channel 11.

FIG. 7 illustrates the cross section of the handheld power tool 1 illustrated FIG. 6 in which the piston 3 of the engine 10 is illustrated in the bottom dead centre. In FIG. 7 a scavenging channel 19 of the engine 10 can be seen. The scavenging channel 19 fluidly connects the crankcase 5 and the cylinder 2. The engine 10 may comprise more than one scavenging channel 19. As is further explained herein, the scavenging channel 19 indicated in FIG. 7 is configured to conduct an air fuel mixture from the crankcase 5 to the cylinder 2 when the piston 3 is in a region of the bottom dead centre.

As indicated in FIG. 5, the piston 3 comprises a piston top 14. Below, simultaneous reference is made to FIG. 5-FIG. 7, if not indicated otherwise. The piston top 14 faces a combustion chamber of the cylinder 2 when the piston 3 is arranged in the cylinder 2. Moreover, as mentioned above, the piston 3 comprises a mantle surface 21. The mantle surface 21 faces cylinder walls 2′ of the cylinder 2 when the piston 3 is arranged in the cylinder 2. The mantle surface 21 is provided with apertures 23 arranged to superimpose the stratified scavenging intake 11 and the scavenging channel 19 when the piston 3 is in a region of the top dead centre. That is, when the piston 3 is in the top dead centre, as illustrated in FIG. 6, air can flow from the throttle 53 into the crankcase 5 via the manifold and the air inlet 9.

Moreover, when the piston 3 is in the top dead centre, the fuel injector 36 may inject fuel into the crankcase 5. Furthermore, as is further explained herein, when the piston 3 is in the region of the top dead centre, as illustrated in FIG. 6, air can flow from the throttle 53 into the scavenging channel 19 indicated in FIG. 7, via the stratified scavenging intake channel 11, recesses 23 in a mantle surface of the piston 3 and an inlet port 19′ of the scavenging channel 19, indicated in FIG. 7. The apertures 23 in the piston 3 may also be referred to as recesses. According to the illustrated embodiments, the piston 3 comprises two apertures 23 and the engine 10 comprises two scavenging channels 19. However, only one of the scavenging channels 19 can be seen in FIG. 7. According to further embodiments, the piston 3 may comprise one aperture 23 and the engine 10 may comprise one scavenging channel 19.

In the following, the operation of the engine 10 will be explained with simultaneous reference to FIG. 5-FIG. 7 during two strokes of the engine 10, i.e. during one revolution of the crankshaft 52 of the engine 10. As mentioned, when the piston 3 is in a region of the top dead centre, as illustrated in FIG. 6, air can flow from the throttle 53 into the crankcase 5 via the manifold and the air inlet 9. Moreover, when the piston 3 is in a region of the top dead centre, the fuel injector 36 may inject fuel directly into the crankcase 5. According to some embodiments, the fuel injector 36 may inject fuel into the crankcase 5 in a continuous manner. Furthermore, when the piston 3 is in the region of the top dead centre, air can flow from the throttle 53 into the scavenging channel 19 indicated in FIG. 7, via the stratified scavenging intake channel 11, the recesses 23 in the mantle surface of the piston 3 and the inlet port 19′ of the scavenging channel 19.

When the piston 3 moves from the top dead centre towards the bottom dead centre, a lower surface of the piston 3, which faces the crankcase 5, acts as a pump which increases the pressure in the crankcase 5. Even when the piston 3 has moved a distance from the top dead centre, the mantle surface 21 of the piston 3 blocks the air inlet 9 and the stratified scavenging intake channel 11.

However, when the piston 3 reaches a first position relative the cylinder 2 in its movement towards the bottom dead centre, an exhaust port 16 arranged in a cylinder wall 2′ of the cylinder 2 is opened to allow exhaust gases to flow out from the cylinder 2. The exhaust port 16 is fluidly connected to the muffler 51 of the engine 10. The piston 3 continues the movement towards the bottom dead centre and when it reaches a second position, below the first position, an inlet port 19′ arranged in the cylinder wall 2′ is opened. The inlet port 19′ is fluidly connected to the crankcase 5 via the scavenging channel 19. The air/fuel mixture in the crankcase 5 is forced to flow into the cylinder 2 via the inlet port 19′ by the overpressure in the crankcase 5.

As can be seen in FIG. 7, in this type of engine 10, the exhaust port 16, and the inlet port 19′ in the cylinder 2 are open simultaneously in the scavenging phase of the engine 10, i.e. when the piston 3 is in the region of a bottom dead centre. As a result thereof, some air/fuel mixture may flow through the cylinder 2 from the inlet port 19 to the exhaust port 16 in the scavenging phase. However, since clean air, i.e. air without added fuel, has flowed into the scavenging channel 19 via the inlet port 19′ from the stratified scavenging intake channel 11 when the piston 3 was in the region of the top dead centre, clean air will first enter the cylinder 2, when the inlet port 19′ is opened in the scavenging phase. In this manner, the amounts of unburnt hydrocarbons generated by the engine 10 is significantly reduced. This because a lower amount of air/fuel mixture will flow through the cylinder 2 from the inlet port 19 to the exhaust port 16 in the scavenging phase.

When the piston 3 moves from the bottom dead centre towards the top dead centre, the mantle surface 21 of the piston 3 closes the inlet port 19′ and then the exhaust port 16 and the air/fuel mixture in the cylinder 2 is compressed by the movement of the piston 3 towards the top dead centre. When the piston 3 reaches a certain position in the cylinder 2, usually a number of crank angle degrees before top dead centre, the air/fuel mixture is ignited by a spark plug 58 of the engine 10. The increased pressure and temperature in the cylinder 2 are partially converted into mechanical work supplied to the crankshaft 52 during movement of the piston 3 from the top dead centre towards the bottom dead centre.

Thus, since the engine 10 of the handheld power tool 1 comprises a stratified scavenging intake channel 11, the engine 10 has conditions for a significant reduction of emission of unburned hydrocarbon during operation. Accordingly, a handheld power tool 1 is provided having conditions for a powerful and low weight engine 10 which is capable of operating in a more environmentally friendly manner.

As is indicated in FIG. 6 and FIG. 7, the stratified scavenging intake channel 11 is configured to conduct air along a first direction d1 towards the cylinder 2. The first direction d1 coincides with an extension direction of the stratified scavenging intake channel 11. As is indicated in FIG. 6 and FIG. 7, the angle a3 between the separation plane Sp and the first direction d1 is approximately 18.5 degrees. According to further embodiments, the angle a3 between the separation plane Sp and the first direction d1 may be less than 35 degrees or may be less than 25 degrees. Thereby, conditions are provided for a compact handheld power tool 1 having a low vertical height despite the fact that the handheld power tool 1 comprises the stratified scavenging intake channel 11, the vibration split, and the control device 28, which each occupies space.

In embodiments in which the separation plane Sp comprises a number of sections being curved/undulated, the feature that the angle a3 between the separation plane Sp and the first direction d1 is less than 35 degrees or is less than 25 degrees, means that the angle a3 between the first direction d1 and the average direction da of the separation plane Sp, located in the interface between the handle portion 4 and the engine portion 6, is less than 35 degrees or is less than 25 degrees.

Moreover, as is indicated in FIG. 6 and FIG. 7, according to the illustrated embodiments, the control device 28 is mounted to the handheld power tool 1 such that the angle a4 between the first direction d1 and one of the two larger sides s1, s1′ of the control device 28 is approximately 10 degrees. According to further embodiments, the control device 28 may be mounted to the handheld power tool 1 such that the angle a4 between the first direction d1 and one of the two larger sides s1, s1′ of the control device 28 is less than 25 degrees or is less than 15 degrees. Thereby, conditions are provided for a compact handheld power tool 1 having a low vertical height despite the fact that the handheld power tool 1 comprises the stratified scavenging intake channel 11, the vibration split, and the control device 28 each occupying space.

Furthermore, as can be seen in FIG. 6 and FIG. 7, according to the illustrated embodiments, the control device 28 is arranged adjacent to the stratified scavenging intake channel 11. That is, in more detail, according to the illustrated embodiments, the control device 28 is arranged between the outer wall 6′ of the engine portion 6 which faces the void space 12′, indicated in FIG. 3, and the stratified scavenging intake channel 11 indicated in FIG. 6 and FIG. 7. Due to these features, the control device 28 is arranged on the handheld power tool 1 in a space efficient manner which provides conditions for a more compact handheld power tool 1 having a low vertical height despite the fact that the handheld power tool 1 comprises the stratified scavenging intake channel 11, the vibration split, and the control device 28.

As mentioned above, according to the illustrated embodiments, the fuel injector 36 is configured to inject fuel into the crankcase 5. As an alternative, or in addition, the engine 10 may comprise a fuel injector configured to inject fuel into the air inlet 9. Moreover, as mentioned above, the control device 28 accommodates an electronic control unit 28′, indicated in FIG. 4, wherein the electronic control unit 28′ is configured to control operation of at least one electronic component 36′ of the power tool 1. In more detail, according to the illustrated embodiments, the electronic control unit 28′ of the control device 28 is configured to control operation of the fuel injector 36. The electronic control unit 28′ of the control device 28 may be configured to control the operation of one or more further arrangements, systems, or components of the handheld power tool 1. Purely as examples, the electronic control unit 28′ of the control device 28 may be configured to control the operation of the spark plug 58, the throttle 53, one or more output units of the handheld power tool 1, such as one or more signalling lamps, or the like.

According to some embodiments, the control device 28 is resiliently suspended to the engine portion 6 of the power tool 1, such as via a number of elastic elements, such as rubber elements. Moreover, according to some embodiments, the control device 28 is resiliently suspended to a structure via a number of elastic elements, wherein the structure is resiliently suspended to the engine portion 6 of the power tool 1 via a number of elastic elements. Such a structure may be considerable larger in size than the control device 28 and may resiliently support a number of further components of the power tool 1 relative to the engine portion 6 of the power tool 1. In this manner, due to the above features, the control device 28 is subjected to less vibration during operation of the power tool 1 and a more durable and reliable power tool 1 can be provided.

The control device 28 and/or the electronic control unit 28′ thereof may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control device 28 and/or the electronic control unit 28′ thereof may further comprise a memory unit, wherein the calculation unit may be connected to the memory unit, which may provide the calculation unit with, for example, stored programme code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control device 28 and/or the electronic control unit 28′ thereof may be connected to components of the handheld power tool 1 for receiving and/or sending input and output signals. These input and output signals may comprise waveforms, pulses, or other attributes which the input signal receiving devices can detect as information and which can be converted to signals processable by the control device 28 and/or the electronic control unit 28′ thereof. These signals may then be supplied to the calculation unit. Each of the connections to the respective components of the handheld power tool 1 for receiving and sending input and output signals may take the form of one or more from among a cable, a data bus, e.g. a CAN (controller area network) bus, or some other bus configuration, or a wireless connection.

The wording “substantially parallel to”, as used herein, may encompass that the angle between the objects referred to is less than 10 degrees, or is less than 7 degrees.

The wording “substantially perpendicular to”, as used herein, may encompass that the angle between the objects referred to is within the range of 80-100 degrees or is within the range of 83-97 degrees.

The wording “substantially aligned with”, as used herein, may encompass that the angle between the objects referred to is less than 10 degrees, or is less than 7 degrees.

The wording “substantially planar”, as used herein, may encompass that the object referred to deviates less than 10% from the shape of a flat plane.

The average direction da of the separation plane Sp, as referred to herein, may be average direction da extending in a plane perpendicular to the horizontal centre plane Hcp and perpendicular to the vertical centre plane Vcp of the power tool 1, i.e. in a plane perpendicular to the viewing direction of FIG. 1, FIG. 3, FIG. 6, and FIG. 7. Such a plane may also be referred to as a longitudinal centre plane of the power tool 1.

In other words, the average direction da of the separation plane Sp, as referred to herein, may be measured in a plane perpendicular to the horizontal centre plane Hcp and perpendicular to the vertical centre plane Vcp of the power tool 1, which plane also may be referred to as a longitudinal centre plane of the power tool 1.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A handheld power tool comprising a tool and an engine configured to power the tool, wherein the power tool comprises a handle portion comprising a handle and an engine portion comprising the engine,
wherein the engine portion is resiliently suspended to the handle portion via a number of resilient members,
wherein the power tool has a horizontal centre plane being parallel to a flat horizontal support surface when the power tool is positioned in a usual upright parking position thereon,
the power tool further having a vertical centre plane being perpendicular to the horizontal centre plane, and
a void space between the handle portion and the engine portion extending along a separation plane, wherein the separation plane is transversal to the horizontal centre plane and to the vertical centre plane,
wherein the power tool comprises a control device accommodating an electronic control unit configured to control operation of at least one electronic component of the power tool,
the control device comprising two larger sides having larger dimensions than other sides of the control device,
and wherein the control device is mounted to the handheld power tool such that an angle between the separation plane and one of the two larger sides is less than 35 degrees.

2. The power tool according to claim 1, wherein the control device is mounted adjacent to the void space.

3. The power tool according to claim 1, wherein the control device is mounted in the engine portion.

4. The power tool according to claim 1, wherein the control device is mounted in the handle portion.

5. The power tool according to claim 1, wherein the power tool comprises a fuel tank arranged in the handle portion.

6. The power tool according to claim 5, wherein an outer surface of the fuel tank faces the void space.

7. The power tool according to claim 1, wherein an angle between the separation plane and the horizontal centre plane of the power tool is within the range of 10-70 degrees.

8. The power tool according to claim 1, wherein the engine is a two stroke engine comprising:
a cylinder,
a piston arranged to reciprocate in the cylinder between a bottom dead centre and a top dead centre,
a crankcase,
an air inlet connected to the crankcase, and
a stratified scavenging intake channel configured to conduct air along a first direction to the cylinder, and
wherein an angle between the separation plane and the first direction is less than 35 degrees.

9. The power tool according to claim 8, wherein the control device is mounted to the handheld power tool such that the angle between the first direction and one of the two larger sides is less than 25 degrees.

10. The power tool according to claim 8, wherein the control device is arranged adjacent to the stratified scavenging intake channel.

11. The power tool according to claim 8, wherein the engine comprises a scavenging channel configured to conduct an air fuel mixture from the crankcase to the cylinder when the piston is in a region of the bottom dead centre, and wherein the piston comprises a mantle surface provided with an aperture arranged to superimpose the stratified scavenging intake channel and the scavenging channel when the piston is in a region of the top dead centre.

12. The power tool according to claim 8, wherein the power tool comprises a fuel injector configured to inject fuel into the crankcase or into the air inlet.

13. The power tool according to claim 12, wherein the electronic control unit of the control device is configured to control operation of the fuel injector.

14. The power tool according to claim 1, wherein the power tool is a chainsaw.
